(19) United States
(12) Patent Application Publication
(10) Pub. No.: US 2010/0283308 A1
(43) Pub. Date: Nov. 11, 2010

(54) CO-INJECTION MOLDED CHAIR

(75) Inventors: Adam Daniel DESKEVICH, Pennsburg, PA (US); Hendrik Richard VAN HEKKEN, Allentown, PA (US)

Correspondence Address: MCNEES WALLACE & NURICK LLC, 100 PINE STREET, P.O. BOX 1166, HARRISBURG, PA, 17108-1166, US

(73) Assignee: KNOLL, INC., East Greenville, PA (US)

(21) Appl. No.: 12/775,538

(22) Filed: May 7, 2010

Related U.S. Application Data
(60) Provisional application No. 61/177,012, filed on May 11, 2009.

(51) Int. Cl. A47C 5/12; B29C 45/16

(52) U.S. Cl. 297/451.11; 264/46.4

(57) ABSTRACT

The invention is directed to an article made from co-injection molding. The article has an inner material and an outer material. The inner material has a blowing agent uniformly distributed throughout the inner material. The outer material surrounds the inner material. The use of the blowing agent in the inner material produces a repeatable and consistent structure, as the blowing agent is uniformly activated through the product.

### FIELD OF THE INVENTION

The present invention is directed to a chair which is manufactured from a co-injection molding process, and more particularly to a chair which is suitable for use in professional environments such as an office.

### BACKGROUND OF THE INVENTION

Molded chair shells have been well known in the art for some time. A typical example of a molded chair shell is disclosed in U.S. Pat. No. 3,669,496, which includes a single, molded piece that forms the seat and the seat back. The chair further requires a frame, i.e., a back support, to which the molded piece is attached. Another example of a molded chair is disclosed in U.S. Pat. No. 3,751,109, which shows a single, molded piece with legs attached at the bottom. This chair does not have a back support and therefore may be prone to material failure.

U.S. Pat. No. 5,985,188 discloses a method and mold design for forming a molded chair seat portion and chair back support portion using air counterpressure and two different materials in an injection molding procedure. The two different materials comprise a first material having a low flexural modulus and the other material having a high flexural modulus. Other additives for tailoring the physical properties of the molded product are added to the mixture of the two materials. The air counterpressure is achieved using shop air pressure. The mold may be used to form the seat portion and the back support portion with a single stroke. An endothermic foaming agent is added to the mixture of the two materials to reduce the weight of the finished part, to reduce cycle time, and to assist in the uniform distribution of the materials that are injected into the mold cavity by the injection nozzle.

U.S. Pat. No. 7,600,820 discloses a molded chair shell which includes a seat portion and a back portion joined at a junction area. A support or reinforcement member is located at the junction area and is formed integrally with the seat portion and the back portion. The reinforcement member includes an internal cavity between the seat portion and the back portion that is substantially positioned over the junction area. The cavity is formed by cavity walls, which may form ribs that extend forwardly along the seat portion and upwardly along the back portion of the chair shell. The chair shell may be formed in an injection molding process, and the internal cavity may be formed in a gas assist operation carried out during the injection molding process.

While these molded chairs have been useful, there is a need for a molded chair which is aesthetically pleasing and which provides for increased strength and reduced weight compared to traditional plastic chairs formed with known methods.

### SUMMARY OF THE INVENTION

One aspect of the invention is directed to an article made from co-injection molding. The article has an inner material and an outer material. The inner material has a blowing agent uniformly distributed throughout the inner material. The outer material surrounds the inner material. The use of the blowing agent in the inner material produces a repeatable and consistent structure, as the blowing agent is uniformly activated through the product.

Another aspect of the invention is directed to a method of making a chair. The method comprises: co-injection molding a first portion of an outer material in a mold cavity; co-injection molding an inner layer in a mold cavity inside the first portion of the outer material having a blowing agent uniformly distributed therein; co-injection molding a second portion of the outer material over the inner material in a mold cavity; and removing the completed chair from the mold cavity. The use of the blowing agent in the inner material produces a repeatable and consistent structure, as the blowing agent is uniformly activated through the mold.

Another aspect of the invention is directed to a method of co-injection molding a chair. The method includes, but is not limited to: injecting an outer material into a mold cavity of a mold; stopping the flow of the outer material into the mold cavity when the desired amount of outer material is positioned in the mold cavity; injecting an inner material into the mold cavity of the mold, the inner material having a blowing agent uniformly distributed therein; stopping the flow of the inner material into the mold cavity when the desired amount of inner material is positioned in the mold cavity; again injecting the outer material into the mold cavity, filling the remainder of the mold cavity, thereby sealing off the inner material, allowing the inner material to be encapsulated inside the outer material; again stopping the flow of the outer material into the mold cavity when the desired amount of outer material is positioned in the mold cavity; whereby the use of the blowing agent in the inner material produces a repeatable and consistent structure, as the blowing agent is uniformly activated through the mold.

The method described provides several advantages over, and addresses many of the problems caused by, molding thick pieces of plastic using known methods. As the plastic cools, the blowing agent expands, negating the plastic's tendency to shrink and form voids. This reduces or eliminates the sink marks and other poor aesthetics associated with thick cross sections and reduces undesirable stresses associated with the uneven distribution of material in the chair. The use of the blowing agent also allows for more uniform cells to form, with a better structure. This provides for increased strength and reduced weight compared to traditional plastic chairs formed with known methods. This produces chairs and other parts which have consistent and repeatable sizes and profiles.

By applying the blowing agent only to the inner material, the surface of the inner material is completely encapsulated by the outer material and is not visible to the consumer. In contrast, the outer material, which is visible to the consumer, has no swirling and does not have a porous surface. The smooth finish of the outer material is displayed to provide the pleasing and consistent aesthetic desired.

In addition, because the endothermic blowing agents absorb heat, the need for external cooling is reduced, thereby reducing cycle times.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of a first embodiment of a co-injection molded chair of the invention.

FIG. 2 is a perspective view of a second embodiment of a co-injection molded chair of the invention.

FIG. 3 is a perspective view of a third embodiment of a co-injection molded chair of the invention.

FIG. 4 is a perspective cross-sectional view taken along line 4-4 of FIG. 4.

FIG. 5 is a diagrammatic view of the co-injection molding process used to manufacture an article according to the present invention.

### DETAILED DESCRIPTION OF THE INVENTION

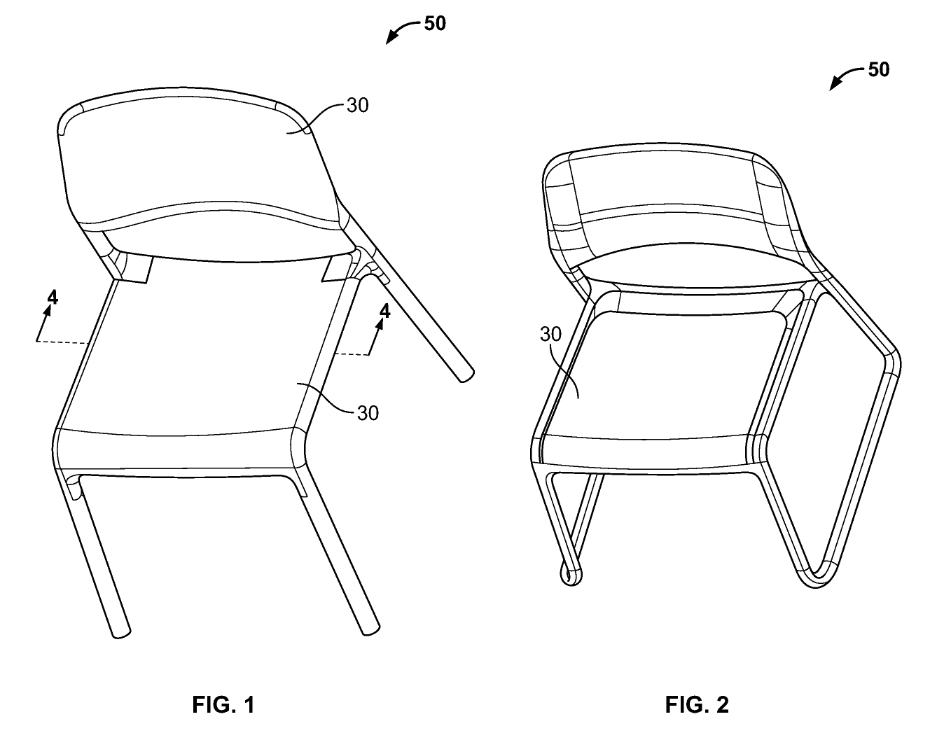

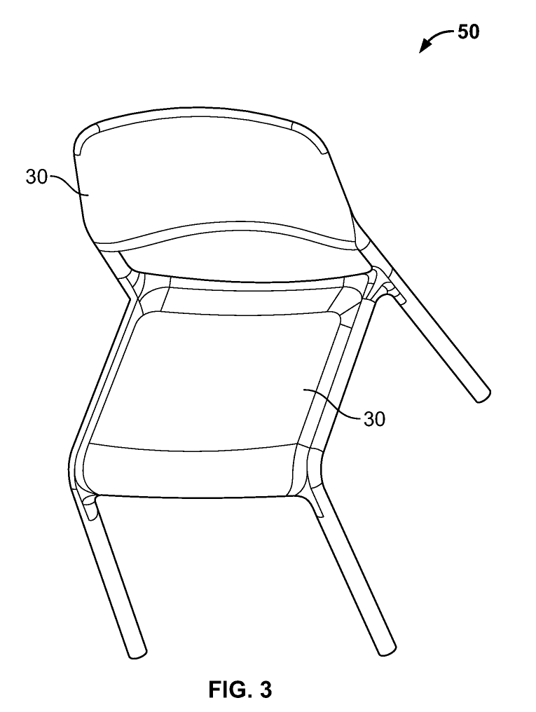

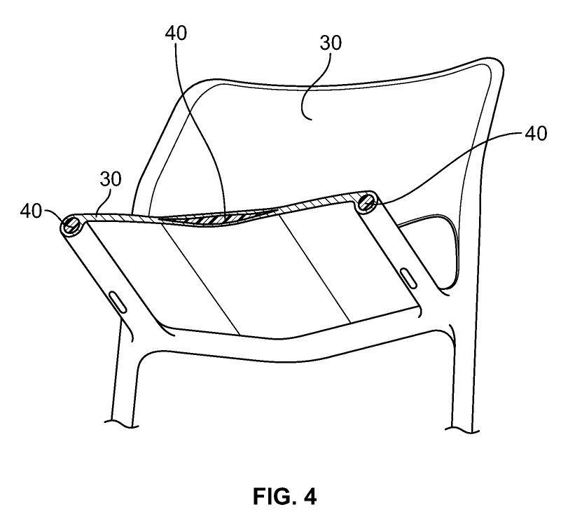

Chairs 50 made by the co-injection molding process herein described are shown in FIGS. 1 through 3. As used herein, the term co-injection molding is meant to refer to a process by which two like or dissimilar plastics (e.g., a skin or outer material 30 and a core or inner material 40) originating from different sources (e.g., injection units 12, 14) are injected into a single mold 16 during a single cycle. The co-injection of the plastics may be sequential or simultaneous, as further described below. Co-injection molding is different from insert molding or overmolding.

Co-injecting the plastics may be done using a substantially sequential process. Typically, plastics are injected through a co-injection manifold and into the mold at temperatures around 300-600 degrees Fahrenheit. The co-injection manifold 10 is typically located between injection units or barrels 12, 14 and a mold 16. A typical co-injection manifold 10 is fixed to the injection units 12, 14. Suitable co-injection manifolds 10 and other co-injection apparatuses which can be used to carry out the methods described herein are known in the industry and will not be described in detail. A wide variety of co-injection apparatuses and co-injection manifolds 10 can be used in conjunction with the invention; the invention is not limited to any particular co-injection apparatus or co-injection manifold 10.

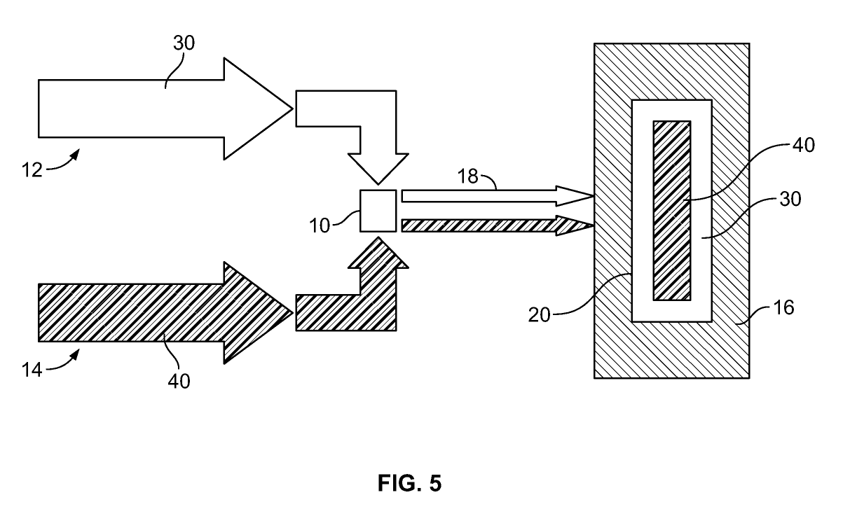

An outer material 30 is injected from a first injection unit 12 through a nozzle 18 (as shown in FIG. 5) or through a manifold 10 and into a mold cavity 20 of the mold 16. The outer material 30 may be, but is not limited to, a synthetic thermoplastic resin, including, but not limited to, glass-filled polypropylene copolymer. The flow of the outer material 30 into the mold cavity 20 is stopped when the desired amount of outer material 30 is positioned in the mold cavity 20. The flow of the inner material 40 is then injected from a second injector unit 14 through the nozzle 18 into the mold cavity 20 of the mold 16. This allows the inner material 40 to be injected inside the outer material 30. The inner material 40 may be, but is not limited to, a thermoplastic resin including, but not limited to, glass-filled polypropylene copolymer. The inner material 40 may comprise the same materials found in the outer material 30. The inner material 40 may also comprise recycled, or ground-up, outer material 30 or inner material 40 that is not useable because it is discolored or otherwise does not meet product specifications. The inner material 40 may also include recycled inner material which includes the blowing agents. The inner material 40 has a viscosity that is comparable to that of the outer material 30.

The flow of the inner material 40 into the mold cavity 20 is stopped when the desired amount of inner material 40 is positioned in the mold cavity 20. The flow of the outer material 30 is then again injected from the first injector unit 12 through the nozzle 18 into the mold cavity 20, filling the remainder of the mold cavity 20. This seals off the inner material 40, allowing the inner material 40 to be encapsulated inside the outer material 30.

When using sequential co-injection, the outer material 30 is first injected into the mold 16 to fill approximately 60-70 percent of the mold cavity 20. The inner material 40 is next injected into the mold 16 to fill approximately 10-20 percent of the mold cavity 20. Subsequently, additional outer material 30 is finally injected into the mold 16 to fill approximately 10-30 percent of the mold cavity 20. However, other percentages of outer material 30 and inner material 40 may be injected into the mold cavity 20 during the different steps without departing from the scope of the invention. A cross-section of a chair 50 made according to the above is shown in FIG. 4.

Alternatively, simultaneous co-injection may be used. In this process the outer material 30 from a first source is injected into the mold cavity 20. After the start of the injection of the outer material 30, the inner material 40 is injected into the mold cavity 20, such that, for a period of time, the inner material 40 and the outer material 30 simultaneously enter the mold cavity 20. The flow of the outer material 30 is terminated while allowing the inner material 40 to continue to flow. The flow of the inner material 40 is then terminated. The outer material 30 is again injected in order to complete the production of the chair 50 or other object. The flow of the outer material 30 is terminated when the mold cavity 20 is full.

Blowing agents may be added to the inner material 40. However, to preserve the aesthetics and functionality of the chair 50, no blowing agent is added to the outer material 30. Blowing agents are any substance which, alone or in combination with other substances, is capable of producing a cellular structure in a plastic. The blowing agents may include, but are not limited to, soluble solids that leave pores in liquids which develop cells when they change to gases, and chemical agents that decompose or react under the influence of heat to form a gas.

An endothermic blowing agent is a blowing agent that absorbs heat. The endothermic blowing agent is added to the inner material 40 before the inner material 40 is injected into the mold cavity 20. A number of known endothermic blowing agents (whether solid or liquid, physical or chemical) are suitable for use in the methods described herein. Any blowing agent having endothermic properties is suitable and the scope of the invention is not limited to any particular blowing agent.

The endothermic blowing agents are added to the inner material 40, preferably before the inner material 40 is injected into the mold 16, and more preferably before the inner material 40 is injected into the manifold 10. Typically, blowing agents are added in amounts equal to about 0.1 to about 1.00 percent by volume of the inner material 40.

In order to trigger the reaction of the blowing agent, whereby the endothermic blowing agent and the inner material 40 begin to expand, external heat must be provided. The heat can be provided in a variety of ways known in the industry. Additionally, the endothermic blowing agent can absorb heat from the outer material 30 after the outer material 30 and inner material 40 mixed with the blowing agent have been injected into the mold cavity 20. The outer material 30, which is wrapped about the inner material 40 mixed with the blowing agent in the mold cavity 20, provides uniform heat exposure to the inner material 40 mixed with the blowing agent. The outer material 30 remains at a relatively uniform temperature across its cross-sections because of its inherent insulating properties. Accordingly, the outer material 30 of the molded chair or product exhibits a relatively constant temperature for a defined period of time for interaction with the inner material 40 mixed with the blowing agent, which provides the heat-activated endothermic blowing agent within the inner material 40 with a controlled exposure to temperature. One of the benefits of uniform temperature exposure is uniform blowing throughout the part. Also, a reduction in the ratio of blowing agent to inner material 40 can be achieved because there is no need to overload the blowing agent in an effort to compensate for non-uniform temperature or cold pocket areas.

Using an endothermic blowing agent in co-injection methods provides several advantages over, and addresses many of the problems caused by, molding thick pieces of plastic using known methods. Without the use of a blowing agent, large voids and shrinkage would occur in areas of thick cross-section, which would adversely impact the aesthetics and functionality of the chair. As the plastic cools, the blowing agent expands, negating the plastic's tendency to shrink and form voids. This reduces or eliminates the sink marks and other poor aesthetics associated with thick cross sections and reduces undesirable stresses associated with the uneven distribution of material in the chair. This produces chairs and other parts which have consistent and repeatable sizes and profiles.

When applying a blowing agent to the plastic material, the blowing agent tends to migrate to the surface of the plastic, causing swirling and a porous surface. By applying the blowing agent only to the inner material 40, the surface of the inner material 40 is completely encapsulated by the outer material 30. Consequently, since the surface of the inner material 40 is completely encapsulated and not visible to the consumer, the poor surface finish of the inner material 40 is not of concern. In contrast, the outer material 30, with no blowing agent mixed in, has no swirling and does not have a porous surface. The smooth finish of the outer material 30 is displayed to provide the pleasing and consistent aesthetic desired.

The use of the blowing agent also allows for more uniform cells to form, with a better structure. This provides the inner or core material, and the entire structure of the chair, with an increased strength and reduced weight compared to traditional plastic chairs formed with known methods, such as molding a chair from material with no blowing agents and injecting gas (gas-assist) thereafter. The use of the blowing agent also produces a more repeatable and consistent structure than previously achievable, as the blowing agent is more uniformly activated through the product.

Another advantage with the process described herein is that parts that do not meet production standards can be ground-up and reused as inner material 40. Reuse of the inner material 40 is facilitated because endothermic blowing agents tend to fully activate during the processes described herein, and therefore are entirely “spent.” As a result, this material can be reground and reliably reused as inner material.

Endothermic blowing agents also tend to remain homogenized when added to the inner material 40. Because the endothermic blowing agents absorb heat, the need for external cooling is reduced, thereby reducing cycle times by five to ten percent.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A chair made from co-injection molding comprising:
a thermoplastic inner material, the inner material having a blowing agent uniformly mixed therein and distributed throughout the inner material;
a thermoplastic outer material surrounding the inner material, the outer material having no blowing agent mixed therein, the outer material having a smooth finish;
whereby the outer material provides an aesthetically pleasing outer surface and the inner material provides a strong core which is free of large voids, the inner and outer materials combining to form an article with a stable profile and repeatable size.

2. The article of claim 1 wherein the blowing agent is an endothermic blowing agent.

3. The article of claim 2 wherein the blowing agent ranges from 0.1 to 1.00 volume percent of the inner material.

4. The article of claim 1 wherein the inner material ranges from 10 to 20% of the volume of the article.

5. The article of claim 1 wherein the outer material ranges from 80 to 90% of the volume of the article.

6. The article of claim 1 wherein the article is a chair.

7. A method of making a chair, the method comprising:
co-injection molding a first portion of an outer material in a mold cavity;
co-injection molding an inner material in the mold cavity inside the first portion of the outer material, the inner material having a blowing agent uniformly distributed therein;
co-injection molding a second portion of the outer material over the inner material in the mold cavity;
removing the completed chair from the mold cavity;
whereby the use of the blowing agent in the inner material produces a repeatable and consistent structure, as the blowing agent is uniformly activated through the mold.

8. The method of claim 7 wherein the outer material does not have a blowing agent.

9. The method of claim 7 wherein the blowing agent is an endothermic blowing agent.

10. The method of claim 10 wherein the blowing agent ranges from 0.1 to 1.00 volume percent of the inner material.

11. The method of claim 7 wherein the inner material ranges from 10 to 20% of the volume of the article.

12. The method of claim 7 wherein the first portion of the outer material ranges from 60 to 70% of the volume of the chair and the second portion of the outer material ranges from 10 to 30% of the volume of the chair.

13. A method of co-injection molding a chair, the method comprising:
injecting an outer material into a mold cavity of a mold;
stopping the flow of the outer material into the mold cavity when the desired amount of outer material is positioned in the mold cavity;
injecting an inner material into the mold cavity of the mold, the inner material having a blowing agent uniformly distributed therein;
stopping the flow of the inner material into the mold cavity when the desired amount of inner material is positioned in the mold cavity;
again injecting the outer material into the mold cavity, filling the remainder of the mold cavity, thereby sealing off the inner material, allowing the inner material to be encapsulated inside the outer material;
again stopping the flow of the outer material into the mold cavity when the desired amount of outer material is positioned in the mold cavity;
whereby the use of the blowing agent in the inner material produces a repeatable and consistent structure, as the blowing agent is uniformly activated through the mold.

14. The method of claim 13 wherein the outer material is a synthetic thermoplastic resin.

15. The method of claim 14 wherein the outer material is a glass-filled polypropylene copolymer.

16. The method of claim 13 wherein the inner material is a synthetic thermoplastic resin.

17. The method of claim 16 wherein the inner material is a glass-filled polypropylene copolymer.

18. The method of claim 13 wherein the inner material includes recycled outer material or inner material.

19. The method of claim 13 where the inner material has a viscosity that is equivalent to that of the outer material.

20. The method of claim 13 wherein the outer material 30 is first injected into the mold to fill approximately 60-70 percent of the mold cavity, the inner material is injected into the mold to fill approximately 10-20 percent of the mold cavity, and the outer material is again injected into the mold to fill approximately 10-30 percent of the mold cavity.
